(19) United States
(12) Patent Application Publication
(10) Pub. No.: US 2014/0174247 A1
(43) Pub. Date: Jun. 26, 2014

(54) HANDLEBAR SHOCK ABSORBER

(71) Applicant: ZYOOM LLC, Ada, MI (US)

(72) Inventors: Judson L. Kovalak, JR., Ada, MI (US); Charles E. Brickey, Rockford, MI (US)

(73) Assignee: ZYOOM LLC, Ada, MI (US)

(21) Appl. No.: 13/722,147

(22) Filed: Dec. 20, 2012

(51) Int. Cl. B62K 21/14

(52) U.S. Cl. CPC B62K 21/14
USPC 74/551.2

(57) ABSTRACT

A handlebar shock absorber is provided. The handlebar shock absorber includes a shock-absorbing cylinder, a knuckle having a lower pivot mount for attachment to the cylinder, and an arm assembly pivotably coupled to the knuckle and including an upper pivot mount for attachment to the cylinder. The cylinder includes an adjustable pre-stressed length to elevate or lower the position of the arm assembly relative to the knuckle. The knuckle is adapted for attachment to a bicycle steering tube, and the arm assembly is adapted for attachment to a bicycle handlebar. In use, the shock-absorbing cylinder dampens movement of the handlebar relative to the steering tube to provide an enhanced ride to the cyclist over rough terrain.

### BACKGROUND OF THE INVENTION

The present invention relates to a handlebar shock absorber for attachment to a bicycle handlebar and a bicycle steering tube.

Bicycles are widely utilized as a means of transportation across improved and uneven terrain. Particularly when traversing uneven terrain, however, bumps, jolts and other vibrations are rapidly transmitted through the bicycle frame to the cyclist. To provide a more comfortable ride, many bicycles now include a suspension system integrated into the bicycle frame. For example, bicycles adapted for rough terrain can include front fork shock absorbers. These shock absorbers typically include a pair of gas springs to absorb vibrations imparted to the front wheel assembly.

More recently, handlebar shock absorbers have been proposed as an aftermarket solution for bicycles lacking sufficient shock absorption. Handlebar shock absorbers have included a coil spring to dampen movement of a handlebar relative to a steering tube. Handlebar shock absorbers according to this general construction are poorly suited for many cyclists, however, and have failed to gain widespread acceptance as either a manufacturer stock component or an aftermarket component for road bicycles, touring bicycles, and mountain bicycles, for example.

### SUMMARY OF THE INVENTION

An improved handlebar shock absorber is provided. The handlebar shock absorber includes an arm assembly, a knuckle pivotably attached to the arm assembly, and a shock-absorbing cylinder to form a triangular linkage having a range of adjustable settings to accommodate a variety of cyclists whose preferences may vary depending on the sitting height of the cyclist, the type of bicycle, and/or the type of terrain.

In one embodiment, the knuckle includes a lower pivot mount for attachment to the cylinder, and the arm assembly includes an upper pivot mount for attachment to the cylinder. The cylinder includes an adjustable pre-stressed length to elevate or lower the position of the arm assembly relative to the knuckle. In use, the cylinder dampens movement of the arm assembly relative to the knuckle to provide an enhanced ride to the cyclist over uneven terrain.

In another embodiment, the shock-absorbing cylinder includes a housing cap and a gas spring moveable within the housing cap to provide a selectable pre-stressed length. The housing cap is joined to the upper pivot mount, and the gas spring is joined to the lower pivot mount. The gas spring includes a Schrader valve and is pre-loaded with compressed air to provide an adjustable dampening force. Adjustment of the dampening force can be accomplished with the addition or reduction of air within the gas spring, and independent of the pre-stressed length of the shock-absorbing cylinder.

In even another embodiment, the shock-absorbing cylinder includes an adjustable gas spring having a Schrader valve, and a lower end cap extending over the Schrader valve and threadedly coupled to the gas spring. The end cap includes a journaled arch in alignment with an opening in the lower pivot mount, such that removal of the end cap allows access to the Schrader valve for adjustment of the gas spring. Once the gas spring is adjusted to the desired pressure, the end cap can be reapplied to the gas spring and aligned with the lower pivot mount for attachment to the knuckle.

In still another embodiment, the arm assembly includes a forward end portion and a rearward end portion. The forward end portion includes a bracket for attachment to a handlebar, and the rearward end portion is pivotably mounted to the knuckle. The arm assembly additionally includes a convex upper surface defining an aperture. The upper pivot mount extends upwardly from the upper surface for attachment to the cylinder, which partially extends through the upper surface aperture.

In yet another embodiment, the knuckle includes an upper portion captured within the arm assembly and a lower pivot mount forward of a bicycle steering tube. The height-adjustable cylinder extends upwardly from the lower pivot mount to pierce through the arm assembly at the point of attachment to the upper pivot joint. The knuckle, arm assembly and cylinder thereby cooperate to form a triangular linkage having a height-adjustable compressible member to dampen vibrations in the handlebar.

These and other features and advantages of the present invention will become apparent from the following description of the invention in accordance with the accompanying drawings and appended claims.

### BRIEF DESCRIPTION OF THE DRAWINGS

FIG. 1 is a rear perspective view of a handlebar shock absorber mounted to a bicycle in accordance with an embodiment of the present invention.

FIG. 2 is a front perspective view of the handlebar shock absorber of FIG. 1.

FIG. 3 is an exploded perspective view of an arm assembly in accordance with an embodiment of the present invention.

FIG. 4 is a top elevation view of the arm assembly of FIG. 3.

FIG. 5 is a front perspective view of a knuckle in accordance with an embodiment of the present invention.

FIG. 6 is a perspective view of a cylinder in accordance with an embodiment of the present invention.

FIG. 7 is a cross-sectional view of the cylinder of FIG. 6.

FIG. 8 is an exploded perspective view of the cylinder of FIG. 6.

FIG. 9 is an elevational view of the handlebar shock absorber of FIG. 1 in a pre-loaded condition.

FIG. 10 is an elevational view of the handlebar shock absorber of FIG. 1 in a first loaded condition.

FIG. 11 is an elevational view of the handlebar shock absorber of FIG. 1 in a second loaded condition.

### DETAILED DESCRIPTION OF THE CURRENT EMBODIMENT

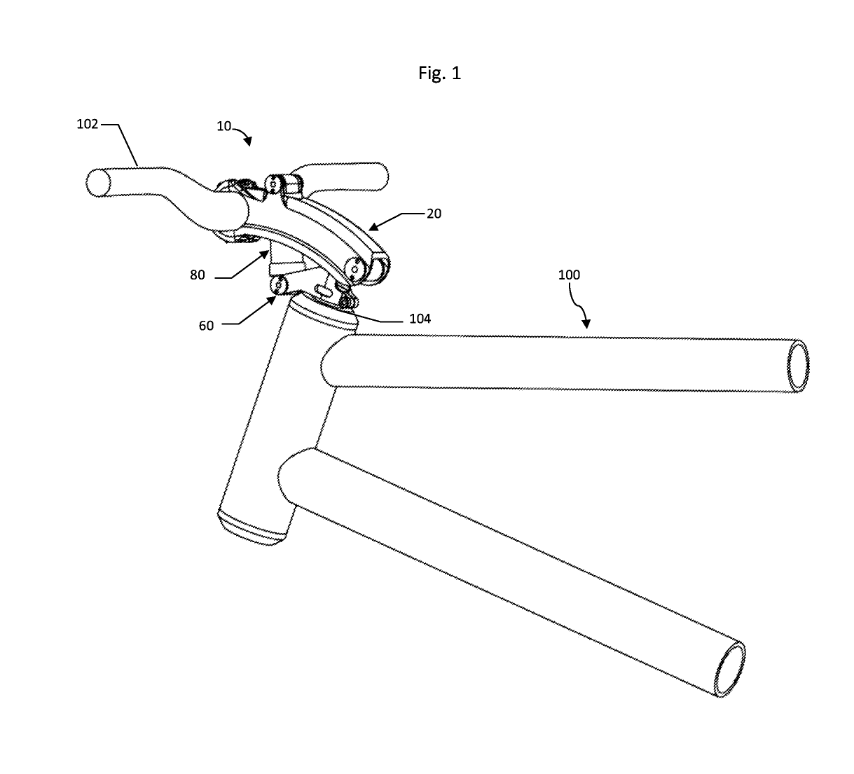

With reference to FIG. 1, a handlebar shock absorber in accordance with one embodiment is illustrated and generally designated 10. The handlebar shock absorber 10 includes an arm assembly 20, a knuckle 60, and a shock-absorbing cylinder 80. A handlebar 102 is received within a forward portion of the arm assembly 20, and the knuckle 60 is non-rotatably mounted to a steering tube 104. As set forth more fully below, the shock-absorbing cylinder 80 extends between the arm assembly 20 and the knuckle 60 to dampen vibrations in the steering tube 104 that would otherwise transfer to the handlebar 102 and consequently the cyclist.

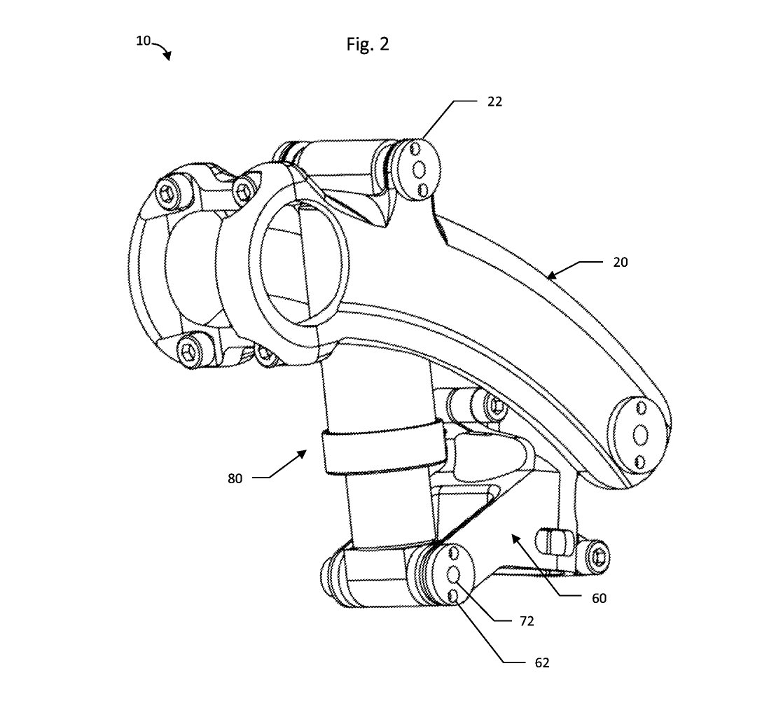

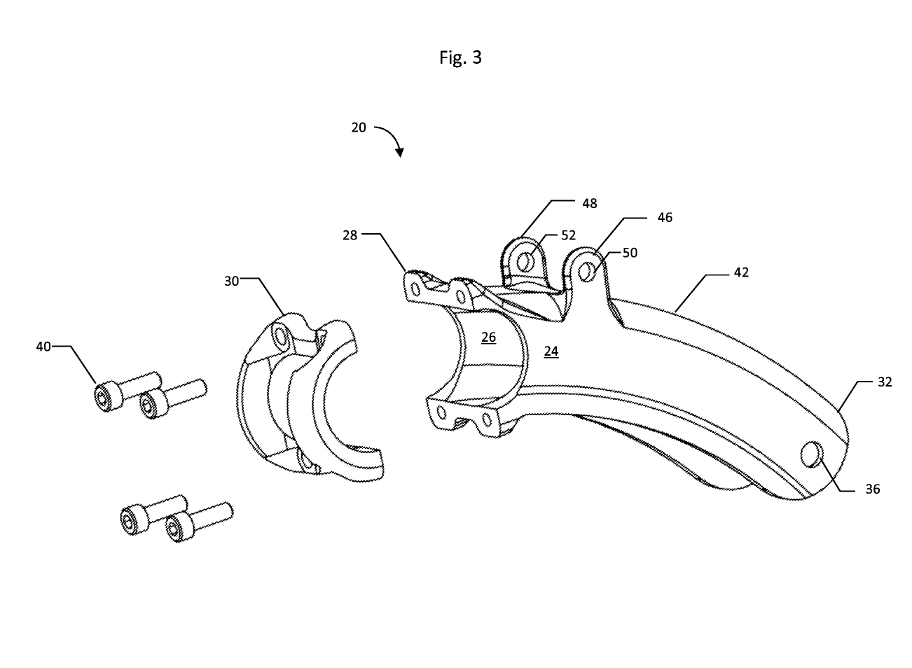

In the present embodiment, the handlebar shock absorber 10 is illustrated on a diamond frame bicycle 100. In other embodiments the handlebar shock absorber 10 can be utilized in combination with other bicycles as desired. The interrelationship of the arm assembly 20, the knuckle 60 and the shock-absorbing cylinder 80 is further shown in FIGS. 2-3. In particular, the arm assembly 20 includes an upper pivot mount 22 for attachment to the cylinder 80, and the knuckle 60 includes a lower pivot mount 62 for attachment to the cylinder 80. The upper pivot mount 22 extends upwardly from the arm assembly 20, and the lower pivot mount 62 extends forwardly and slightly downwardly from the knuckle 60. The shock-absorbing cylinder 80 is oriented generally vertically, piercing the arm assembly 20, such that the cylinder 80 is at least partially housed within the arm assembly 20. As also shown in FIGS. 2-3, the arm assembly 20 is pivotably attached to the knuckle 60 to allow relative rotational movement about a horizontal axis, the movement being impeded or slowed by the shock-absorbing cylinder 80.

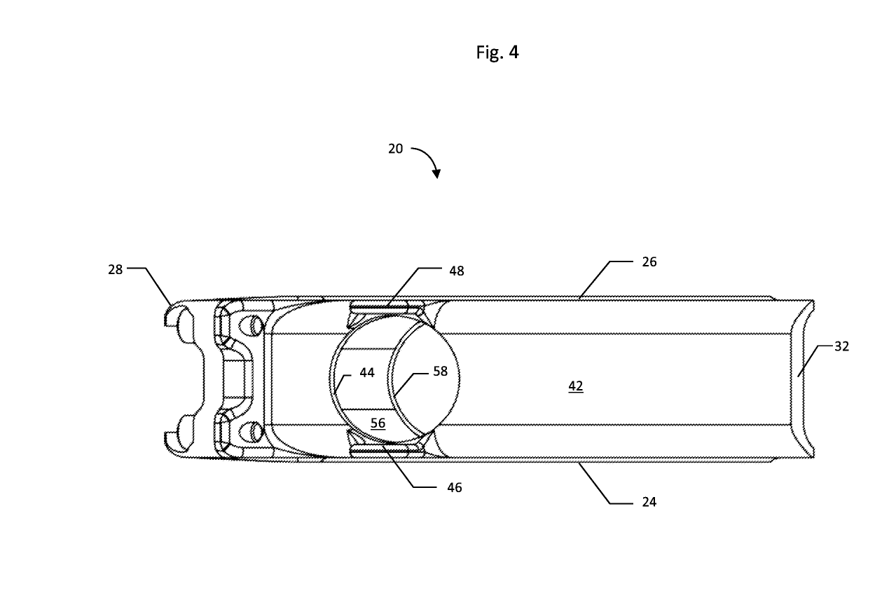

Referring now to FIGS. 3-4, the arm assembly 20 includes opposing lateral sidewalls 24, 26 that are curved to provide the arm assembly 20 with an arcuate side profile. In addition, the arm assembly 20 includes a forward portion 28 opposite a handlebar fastener bracket 30 and a rearward portion 32 including opposing openings 36 for receipt of a first pivot pin 38 therein. The forward portion 28 and the handlebar fastener bracket 30 include cooperating holes to receive one or more bolts 40. The bolts 40 urge the fastener bracket 30 into registration against the handlebar 102 to prevent rotational or translational movement of the handlebar 102 relative to the arm assembly 20.

As also shown in FIGS. 3-4, the arm assembly 20 includes an upper surface 42 and a lower surface 56. The upper surface 42 extends along the length of the arm assembly 20, while the lower surface 56 terminates at an arcuate periphery 58 nearer to the forward portion 28 than to the rearward portion 32. In addition, the upper surface 42 defines an upper aperture 44 between opposing flanges 46, 48 in the upper pivot mount 22. The opposing flanges 46, 48 include opposing openings 50, 52 for receipt of a second pivot pin therein. The upper aperture 44 is sized to accommodate at least a portion of the cylinder 80, such that the cylinder 80 extends at least partially upwardly through the upper surface 42 of the arm assembly 20. The upper aperture 44 is generally circular in the present embodiment, being oversized with respect to the cylinder outer diameter to accommodate a range of motion during a length adjustment of the cylinder 80 and/or an actuation of the cylinder 80. In other embodiments the upper aperture 44 can define other geometries or configurations as desired, however.

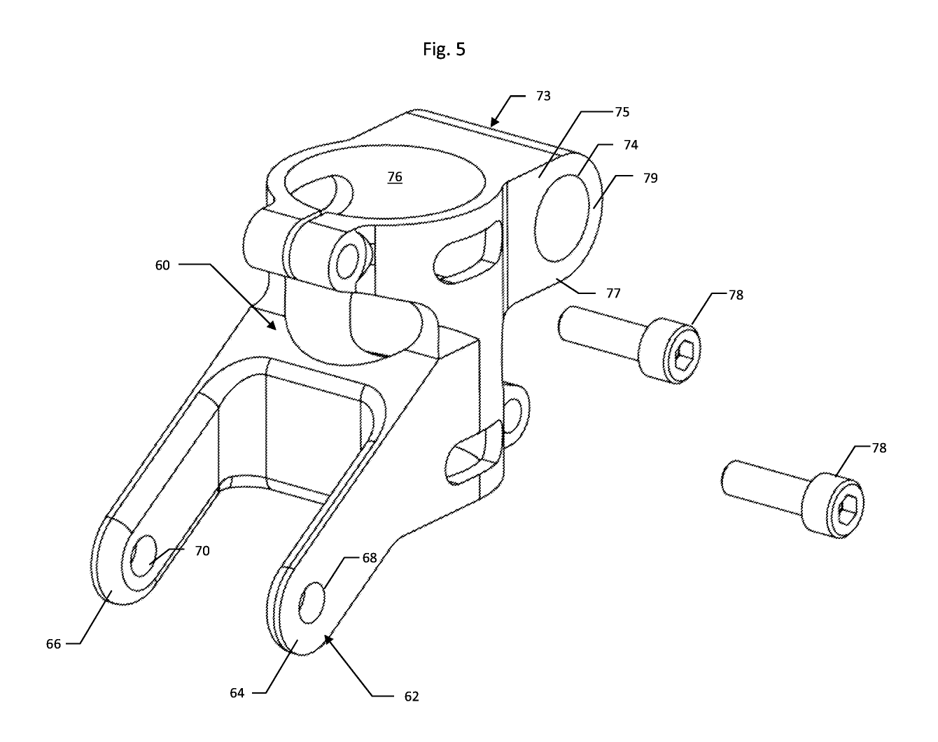

The knuckle 60 is further shown in FIG. 5. As noted above, the knuckle 60 includes a lower pivot mount 62 for attachment to the cylinder 80. The lower pivot mount 62 includes opposing flanges 64, 66 having opposing openings 68, 70 for receipt of a third pivot pin therein. The flanges 64, 66 extend forwardly and downwardly of the steering tube 104, and are vertically thin-walled to withstand the vertical load imparted by the cylinder 80. As also shown in FIG. 5, the knuckle 60 includes a transverse channel 74 for receipt of the first pivot pin 38 therein. The first pivot pin 38 is seated within the channel 74, being generally perpendicular to the steering tube 104 to permit rotation of the arm assembly 20 about a generally horizontal axis. In addition, the knuckle 60 includes a cylindrical bore 76 for attachment to the steering tube 104. Tightening of two bolts 78 operates to securely fasten the knuckle 60 to the steering tube 104, such that the knuckle 60 is prevented from movement along or about the steering tube 104. In this regard, rotation of the knuckle 60 about a vertical axis causes a rotation of the steering tube 104 and consequently the bicycle front tire.

As also shown in FIG. 5, the transverse channel 74 is positioned aft of the cylindrical bore 76, being concealed from view between the left and right sidewalls 24, 26 when coupled to the arm assembly 20. In particular, the transverse channel 74 is formed in a laterally elongated arch 73. The laterally elongated arch 73 includes an upper segment 75, a lower segment 77, and a contoured portion 79 extending therebetween. The upper segment 75 is generally aligned with the upper opening to the cylindrical bore 76, and the lower segment 77 is located approximately midway between the upper opening to the cylindrical bore 76 and the lower opening to the cylindrical bore 76. In this configuration, the transverse channel 74 is positioned above and rearward of the lower pivot mount 62. By separating the transverse channel 74 and lower pivot mount 62 as shown in FIG. 5, the cylinder 80 can be oriented generally perpendicular to the attachment arm 20 as shown in FIG. 2 above.

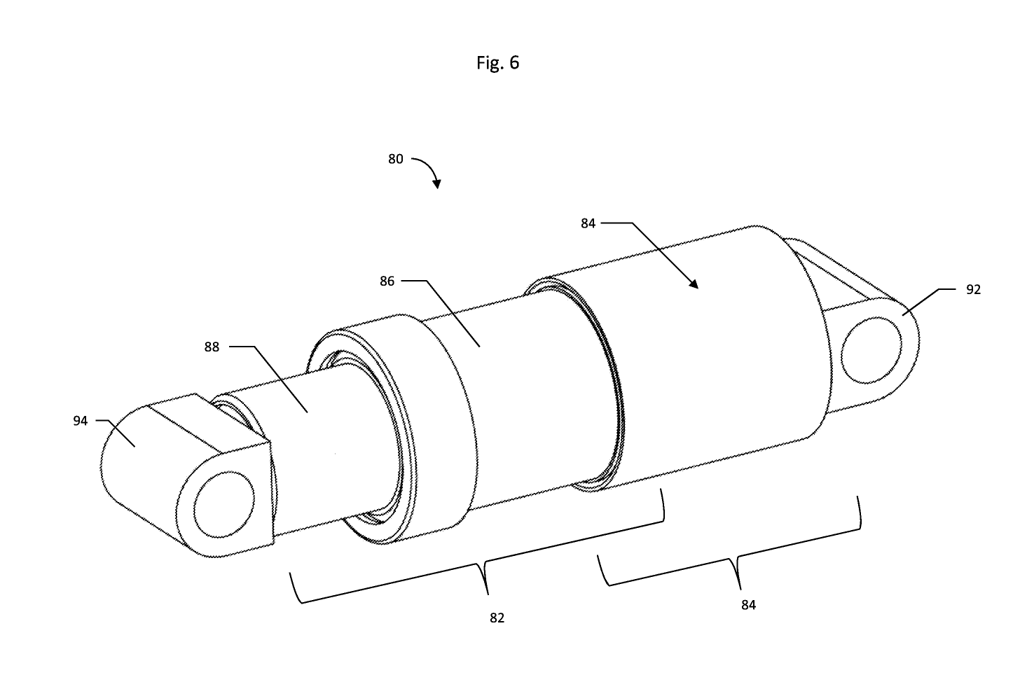

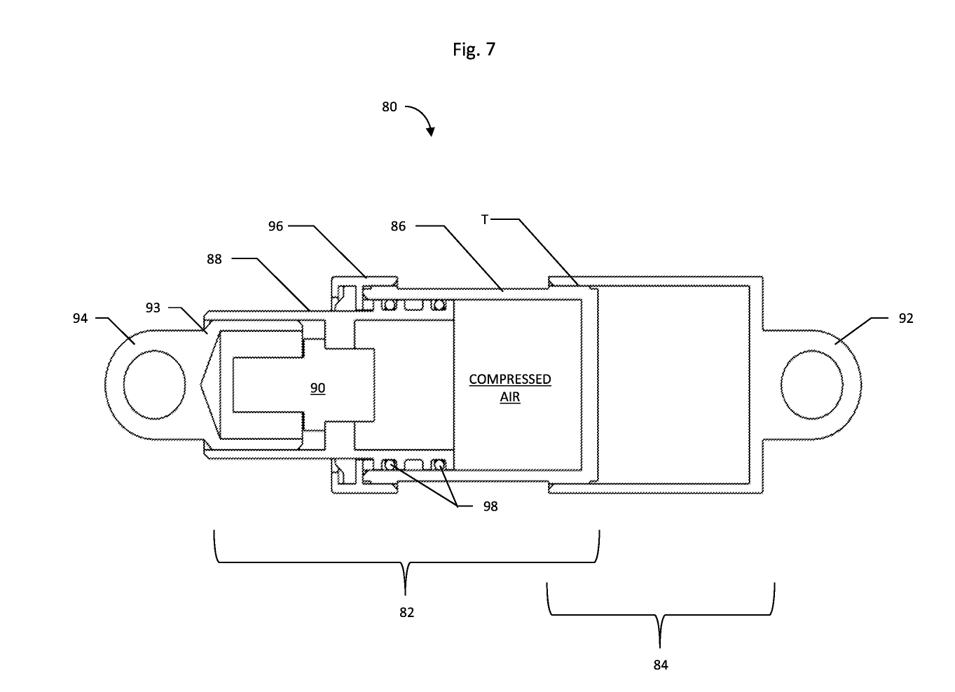

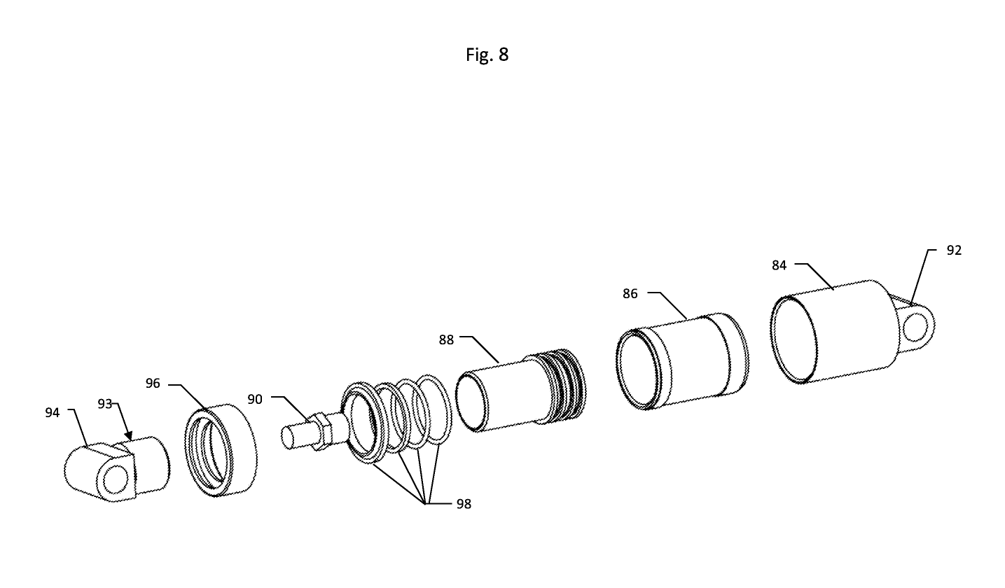

Referring now to FIGS. 6-8, the shock-absorbing cylinder 80, also referred to herein as a shock absorbing element, is generally adapted to selectively lengthen or shorten to provide the desired handlebar height. In the present embodiment, the cylinder 80 includes a biasing element 82 seated within a housing cap 84. The biasing element 82 includes a gas spring in the present embodiment, but can include other constructions in other embodiments, including for example a coil spring. The gas spring 82 includes an upper portion 86 movable relative to a lower portion 88 when actuated. The upper portion 86 is externally threaded, while the housing cap 84 is internally threaded. The housing cap 84 is therefore threadedly engaged to the gas spring 82 at region “T” in FIG. 7, such that rotation of the gas spring 82 relative to the housing cap 84 imparts a lengthening or shortening of the overall cylinder 80. For example, a clockwise rotation of the gas spring 82 relative to the housing cap 84 shortens the overall cylinder 80, thereby lowering the handlebar 102, while a counter-clockwise rotation of the gas spring 82 relative to the housing cap 84 lengthens the overall cylinder 80, thereby heightening the handlebar 102.

In the present embodiment, lengthening or shortening of the cylinder 80 does not affect the spring force imparted by the gas spring 82. The spring force, sometimes referred to as the dampening force or the spring constant, is separately controlled by manually adjusting the air pressure within the gas spring 82. In the present embodiment, the gas spring 82 includes a Schrader valve 90 extending from the lower portion 88. Increasing the air pressure within the gas spring 82 increases the spring force, while decreasing the air pressure within the gas spring 82 decreases the spring force.

As also shown in FIGS. 6-8, the housing cap 84 includes an upper journal arch 92 for receipt of the second pivot pin therein. In like manner, cylinder 80 includes a lower end cap 93 including a lower journaled arch 94 for receipt of the third pivot pin therein. The lower journaled arch 94 is threadedly received within the gas spring 82 and generally conceals the Schrader valve 90 from view. An outer collar 96 extends circumferentially about the gas spring 82, while multiple o-rings 98 are interposed between the upper and lower portions 86, 88 of the gas spring 82.

In order to access the Schrader valve 90, the third pivot pin is first removed from the lower pivot mount 62 and the lower journaled arch 94. The lower end cap 93 is then unscrewed from the base of the cylinder 80, revealing the Schrader valve 90. Once the desired air pressure is achieved in the gas spring 82, the lower end cap 93 is screwed onto the gas spring 82, and the lower journaled arch 94 is aligned with the lower pivot mount 62 for receipt of the third pivot pin. The pivot pin is thereafter applied through both of the lower pivot mount 62 and the lower journaled arch 94 to interlock the cylinder 80 to the knuckle 60.

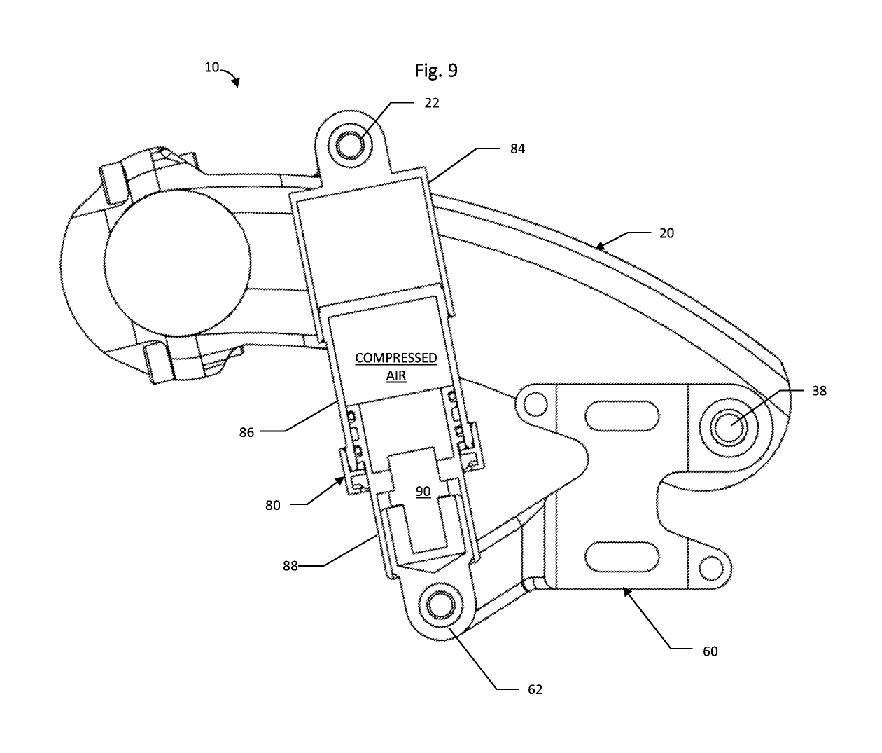

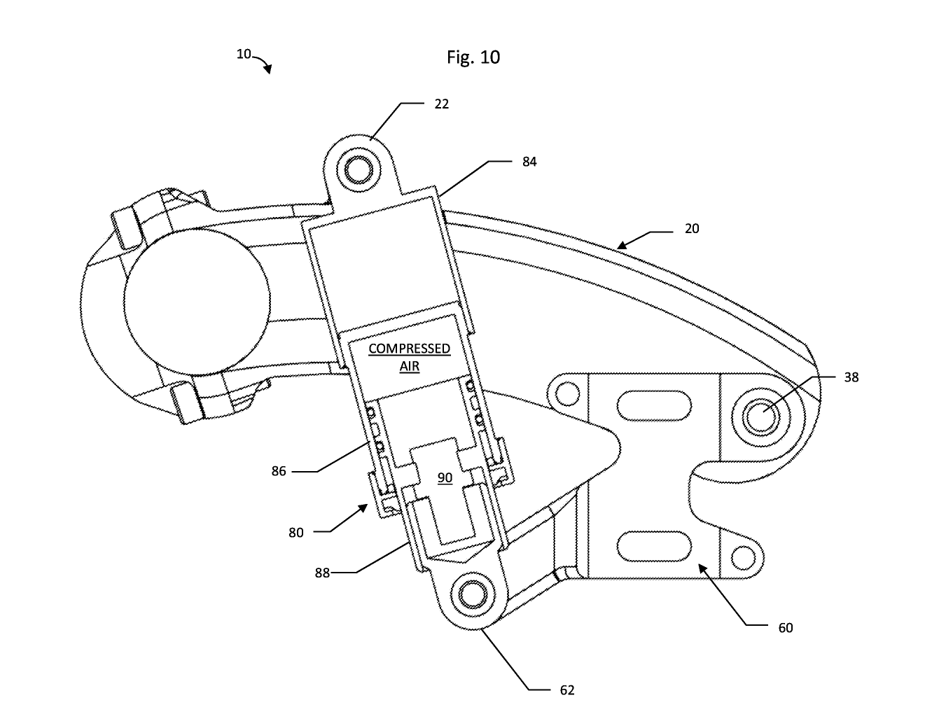

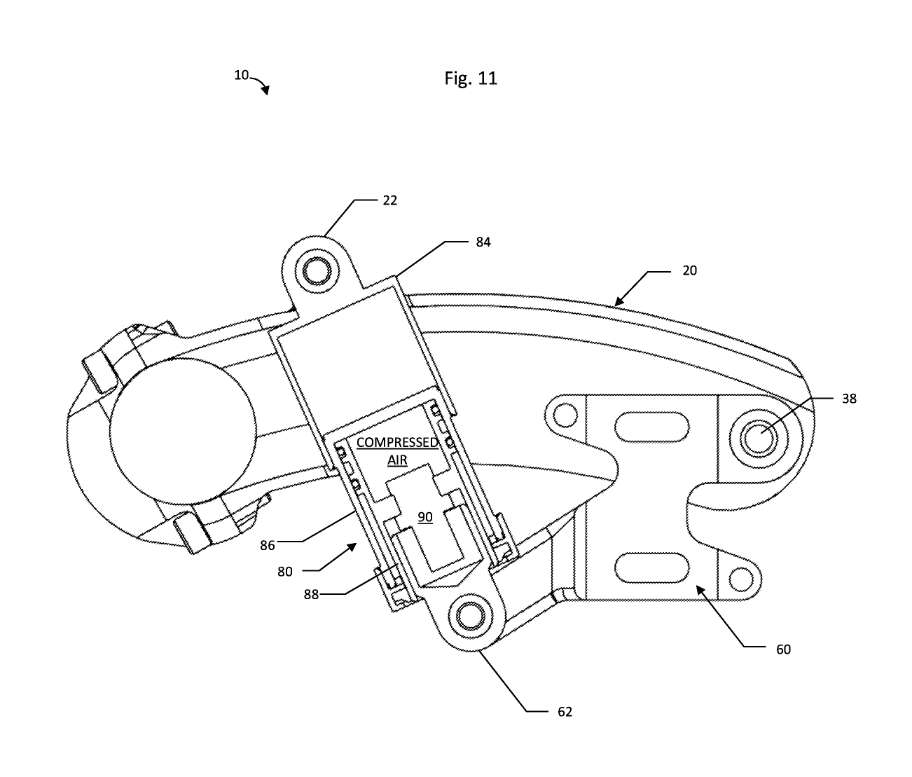

Actuation of the handlebar shock absorber 10 will now be described in connection with FIGS. 9-11. Generally, the handlebar shock absorber 10 is adapted to lessen the shock to the handlebar 102 as much as possible, particularly as the bicycle traverses rough and uneven terrain. In an unstressed state as shown in FIG. 9, the compressed air within the adjustable gas cylinder 82 maintains the upper and lower pivot points 22, 62 apart from each other. In response to an upward jolt or vibration imparted to the front wheel assembly, and consequently to the steering tube 104, the lower pivot mount 62 moves upwardly and reduces the internal volume of the gas spring 82. By reducing the internal volume of the gas spring 82 as shown in FIG. 11 and in FIG. 12, the internal air pressure increases, driving the upper and lower pivot points 22, 62 apart from each other. At the same time, the arm assembly 20, and consequently the handlebar 102, remains generally level with the ground. That is, the jolt or vibration of the steering tube 104 is converted into reciprocal motion of the gas spring 82, and not the handlebar 102, thereby lessening the shock to the cyclist over rough and uneven terrain. While FIGS. 11-12 are oriented with respect to the knuckle 60, the knuckle 60 moves upwardly during actuation of the cylinder 80, while the arm assembly 20 remains generally level.

Accordingly, the handlebar shock absorber 10 of the present embodiment provides a range of adjustable settings to accommodate a variety of cyclists. The cylinder height is manually adjustable in a pre-loaded state, and the cylinder spring force is manually adjustable in a pre-loaded state. By facilitating the manual adjustment of either or both of these features, the handlebar shock absorber 10 can be adapted to each individual cyclist's preferences. Where substantially no shock absorbing capability is desired, the cyclist can pre-load the gas spring to a pressure sufficient to effectively lock the arm assembly 20 in position relative to the knuckle 60.

As the term is used herein, a shock-absorbing cylinder includes any device having a biasing element, including devices having a cylindrical outer sidewall, a rectangular outer sidewall, a hexagonal outer sidewall, and no outer sidewall. The biasing element can include for example the adjustable gas spring noted above, and can also or alternatively include coil springs, struts, hydraulic pistons, wave springs, air springs and generally any device adapted to dampen vibrations along a longitudinal axis.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1.-25. (canceled)

26. A handlebar shock absorber for attachment to a bicycle, the shock absorber comprising:
a shock-absorbing gas cylinder having an adjustable pre-stressed length;
a knuckle having a lower pivot mount for attachment to the gas cylinder; and
an arm assembly pivotably coupled to the knuckle and including an end portion for attachment to a bicycle handlebar and an upper pivot mount rearward of the end portion for attachment to the gas cylinder, wherein the gas cylinder extends between the lower and upper pivot mounts to dampen rotation of the arm assembly relative to the knuckle.

27. The handlebar shock absorber of claim 26 wherein the shock-absorbing gas cylinder is partially concealed within the arm assembly aperture.

28. The handlebar shock absorber of claim 26 wherein the arm assembly includes an upper surface and spaced apart sidewalls.

29. The handlebar shock absorber of claim 26 wherein the knuckle is adapted to be mounted to a bicycle steering tube.

30. The handlebar shock absorber of claim 29 wherein the lower pivot mount extends forwardly of the bicycle steering tube.

31. A handlebar shock absorber comprising:
a shock-absorbing cylinder including upper and lower portions moveable in relation to each other to define a pre-stressed length;
an arm assembly including forward and rearward end portions and an upper pivot mount therebetween, the upper pivot mount being joined to the cylinder upper portion, wherein the cylinder extends downwardly from the upper pivot mount; and
a knuckle pivotably mounted to the arm assembly rearward end portion and including a lower pivot mount joined to the cylinder lower portion, wherein the pre-stressed length of the shock-absorbing cylinder is manually adjustable to elevate or lower the arm assembly relative to the knuckle.

32. The handlebar shock absorber of claim 31 wherein the cylinder upper portion includes a housing cap and wherein the cylinder lower portion includes a gas spring.

33. The handlebar shock absorber of claim 32 wherein the gas spring further includes a dampening force, wherein adjustment of the pre-stressed length of the shock-absorbing cylinder does not vary the dampening force.

34. The handlebar shock absorber of claim 33 wherein the gas spring is adapted to be pre-loaded with compressed air to provide a selectable dampening force.

35. The handlebar shock absorber of claim 31 wherein the arm assembly includes an upper surface and left and right sidewalls, the shock-absorbing cylinder being partially housed therebetween.

36. The handlebar shock absorber of claim 31 wherein the knuckle is adapted to be mounted to a bicycle steering tube.

37. A handlebar shock absorber for attachment to a bicycle steering tube, the handlebar shock absorber comprising:
a knuckle adapted to be non-rotatably mounted to the bicycle steering tube;
an arm assembly pivotably mounted to the knuckle; and
a shock-absorbing cylinder partially housed within the arm assembly and pivotably mounted to the arm assembly and to the knuckle to dampen rotation of the arm assembly relative to the knuckle, the shock-absorbing cylinder including an adjustable pre-stressed length and a spring force, wherein adjustment of the pre-stressed length does not vary the spring force.

38. The handlebar shock absorber of claim 37 wherein the arm assembly includes a bracket for receipt of a bicycle handlebar therein.

39. The handlebar shock absorber of claim 37 wherein the arm assembly includes first and second laterally spaced apart sidewalls for receipt of the knuckle therebetween.

40. A handlebar shock absorber comprising:
a knuckle including a lower pivot mount;
a shock-absorbing cylinder coupled to the lower pivot mount and including:
a gas spring including an internal chamber,
a valve for controlling the flow of gas into the internal chamber, and
an end cap extending over the valve and pivotably coupled to the lower pivot mount; and
an arm assembly including an upper pivot mount for attachment to the cylinder, wherein the cylinder extends between the lower and upper pivot mounts to dampen rotation of the arm assembly relative to the knuckle.

41. The handlebar shock absorber of claim 40 wherein the end cap includes a journaled arch in alignment with an opening in the lower pivot mount.

42. The handlebar shock absorber of claim 40 wherein the end cap is threadedly engaged to the gas spring.

43. The handlebar shock absorber of claim 40 wherein the valve is accessible after removal of the end cap from the gas spring.

44. The handlebar shock absorber of claim 40 wherein the valve is a Schrader valve.
